(19) United States
(12) Patent Application Publication
(10) Pub. No.: US 2007/0292749 A1
(43) Pub. Date: Dec. 20, 2007

(54) BATTERY ASSEMBLY FOR VACUUMS

(76) Inventors: RICHARD COOMBS, BOISE, ID (US); MIKE WILMINK, BOISE, ID (US)

Correspondence Address: DYKAS, SHAVER & NIPPER, LLP, P.O. BOX 877, BOISE, ID, 83701-0877, US

(21) Appl. No.: 11/763,984

(22) Filed: Jun. 15, 2007

Related U.S. Application Data
(60) Provisional application No. 60/804,909, filed on Jun. 15, 2006.

(51) Int. Cl. H01M 2/10

(52) U.S. Cl. 429/96; 429/123; 429/97; 429/98

(57) ABSTRACT

Disclosed is a removable battery pack for use with a vacuum cleaner, for use with a recharging station. The battery pack is used to power a vacuum, and when discharged can be removed and replaced with another charged battery pack.

### CROSS-REFERENCE TO RELATED APPLICATIONS

This application claims the priority date of the provisional application entitled Battery Pack Harness filed by Richard Coombs on Jun. 15, 2006 with application Ser. No. 60/804,909.

### FIELD OF THE INVENTION

The present invention generally relates to an apparatus for use with vacuum cleaners, and more particularly to a battery pack for use with vacuum cleaners.

### BACKGROUND OF THE INVENTION

Vacuum cleaners come in several different configurations, such as backpack vacuums, which are mounted on the user's back as the vacuum is operated. Other configurations include canisters, uprights and other configurations which are commonly known in the vacuum industry. The backpack vacuum in particular has found wide application for use in commercial situations. This can include use in hotels, cleaning airplanes between flights, cleaning commercial office buildings and other situations in which commercial cleaning services would typically clean a facility. The other types of vacuum cleaners are more commonly used in certain other areas due to their different configurations, ease of use, weight and other considerations.

In each of these uses of vacuum cleaners there occur situations in which it is desirable to have a vacuum cleaner that is battery powered. For instance, when cleaning a stairwell in a commercial building, building codes require that there be no electrical outlets in the stairwell. This makes the stairwell difficult to clean, as the cleaning crew must run an extension cord from inside one of the floor into the stairwell region.

In the context of cleaning an airplane between flights the backpack vacuum has proved particularly useful. However, using a backpack vacuum for such work requires managing the extension cords which run from outside the plane into the interior of the plane and dragging the cord the length of the airplane while using the vacuum on upholstery and on the floor. It would be much more advantageous to use a battery powered vacuum.

Another situation in which a battery powered vacuum would be very useful is in a casino, hotel or similar place of business. Casinos in particular are problematic because they are often open 24 hours per day. Even those that have a down period can be problematic; the electrical cords must extend across a lobby or a room and present a trip hazard to both guests and employees. Due to the risk of liability from the trip hazard, it is common for institutions such as these to have a person guarding the cord while another person is operating the vacuum powered by the cord. In these situations utilization of a battery powered vacuum cleaner would make work faster and easier and cheaper by reducing the labor involved in cleaning.

The problem with using a battery powered device for powering a vacuum, is the vacuum must have sufficient power to operate in a manner that it is useful for commercial operations. It is difficult to find a battery which accomplishes this, and it is difficult to keep that battery charged, as rechargeable batteries would be more desirable than interchangeable batteries. Additionally, if rechargeable batteries are used, they must be used in a system which allows basically continuous operation of the vacuum cleaner. The ideal situation would be a vacuum cleaner which uses two battery packs, with the battery packs interchangeable for use and for charging, and when one battery pack is discharged, the other battery pack would be charged and ready for use. To date, such a system has not been achieved.

### SUMMARY OF THE INVENTION

These and other objects are accomplished by the battery pack of the invention. The invention is a battery pack for powering a vacuum cleaner, which is removable from the vacuum cleaner for charging, and which interfits with a charging station for recharging. While one battery pack is being charged, the other battery pack can be used to operate the vacuum cleaner. The battery pack of the invention is configured for use with any type of vacuum, including canisters and uprights, and is particularly adapted for use with a backpack vacuum. Although the battery pack could be utilized with any configuration of vacuum cleaner, the discussion of the invention will refer to a backpack type vacuum, with the understanding that the battery pack of the invention can also be configured to operate with other configurations of vacuum cleaners.

In the instance of the battery pack of the invention being mounted on a backpack vacuum, the battery pack would be in the form of a removable battery assembly. The battery assembly includes a battery plate on which are attached components of the battery pack. The battery plate includes one or more mounting points for attachment to the vacuum, with the battery plate also including one or more battery mounting positions, provided for the attachment of one or more batteries to the battery plate. The battery plate includes an electrical connection unit for interfitting engagement with a corresponding vacuum electrical connection unit. The electrical connection unit is provided for electrical engagement of the batteries on the battery plate with the vacuum motor of the vacuum.

An engagement guide is also provided on the vacuum for interaction with the corresponding engagement profile on the battery plate. The interaction of the guide and the plate ensure correct engagement of the battery plate mounting points to the vacuum and ensures correct engagement of the battery plate electrical connection unit with the vacuum electrical connection unit. The removable battery assembly of the invention also includes a recharging station with an electrical connection unit for corresponding engagement with the battery plate electrical connection unit.

The battery plate may be engaged with the vacuum for a period of time and then be removed from the vacuum and replaced by a fully charged battery plate. The discharged battery plate would be engaged with the recharging station for a period of time. The battery plate engages with the vacuum by use of the engagement guide and the engagement profile in a manner which ensures correct engagement of electrical components.

The recharging station can also include an engagement guide similar to that on the vacuum, for corresponding engagement with the engagement profile of the battery plate. This ensures correct engagement of the battery plate electrical connection unit with the recharging station electrical connection unit.

The removable battery assembly of the invention can be configured to interfit with a backpack vacuum as well as canister, upright or other forms of vacuums. When used with a backpack vacuum, the removable battery assembly could be configured to interfit with an engagement guide on the backpack vacuum in a position between the backpack carrying harness and the backpack vacuum body. When using this arrangement, the removable battery assembly includes a carrying harness with shoulder straps in which the carrying harness is configured to attach to the backpack vacuum. The battery plate is removable from the carrying harness. In this configuration, the carrying harness and removable battery assembly can be interchanged with the carrying harness of conventional backpack vacuums, and thus be a retrofit to existing backpack vacuums. The harness of this version of the device can include one or more mounting points for attachment to the backpack vacuum. It can also include a first end and a second end, with two shoulder straps for providing lifting capability for a user of the backpack vacuum. Each shoulder strap has an upper end and a lower end, with the uppers ends for attachment to the first end of the harness body and with the lower end for attachment to the second end of the harness body. This version of the device can also include a back-contact area attached to the upper section of the harness body in a lumbar contact area attached to the lower section of the harness body. One or more batteries are provided for attachment with the battery mounts on the harness body, with each battery including electrical contacts for engagement with the electrical connection means of the battery mounts.

The harness and battery assembly described above can be configured to include a battery plate with an engagement guide for interaction with a corresponding engagement profile on the battery plate. The guide and the profile ensure correct engagement of the battery plate to the harness body. They also ensure correct engagement of the battery plate electrical connection unit with the harness body electrical connection unit.

The battery plate can also be configured to attach to the vacuum itself, rather than connecting to the harness body. The engagement guide can take a number of configurations, including tracks, rails, slots and grooves or various geometric shapes which interfit with a corresponding geometric shape.

The invention can take the form of a harness for attaching to a backpack vacuum, with the harness including the battery pack, with batteries, battery plate, engagement profile and engagement guide. The harness and the harness assembly would replace the harnesses on existing backpack vacuums, and would also be attached to new vacuums as they are manufactured, to replace the old style harnesses. The harness of the invention includes one or more mounting points for attachment to the backpack vacuum. The mounting points correspond to the mounting points on the backpack vacuum, and would be different for different models of backpack vacuums.

The harness body also has an upper and a lower section, with the upper section corresponding generally to the upper back and shoulder area, and the lower section corresponding to the waist region of the user. The harness body may include one or more battery mounts in which batteries for powering the backpack vacuum may be inserted.

Alternatively, the harness body may include a battery panel, with the battery mounts attached to the battery panel, and the battery panel with its attached batteries and battery mounts being removable to make access easier for replacing batteries or charging batteries. The battery mount and the battery panel could be removable structures, and constructed so that there is an electrical connection for connecting the batteries to the battery mounts.

Two shoulder straps are attached to the harness body. The shoulder straps provide lifting capability for the user of the backpack vacuum when the harness is attached. Each shoulder strap has an upper end and a lower end. The upper end is attached to the upper section of the harness body, and the lower end is attached to the lower section of the harness body.

The harness body also has a back contact area, which is attached to the upper section of the harness body. This back contact area is typically padded to provide comfort in the shoulder and upper back area of the wearer. The harness also has a lumbar contact area, which is attached to the lower section of the harness body and typically provides padding for the comfort of the wearer in the lumbar region. A waist belt attached to the lower section of the harness body is also an optional feature.

The harness also includes one or more batteries for engagement with the battery mounts on the harness body. Each battery includes electrical contacts for engaging with the electrical connection means of the battery mounts. The electrical connection means are configured to interfit with the battery electrical contacts, and to have physical structures which guide the batteries into interfitting contact with the electrical connection means of the harness body. The mounting guides are configured to make an incorrect battery orientation impossible. The batteries may be replaceable and removable, or can be built into the battery panel and supplied to the user in a secure mounting.

The battery panel is removable from the harness assembly. In this configuration the harness body has an electrical connection post. This post is configured for interfitting engagement with an engagement socket of the battery panel. These two electrical connections are configured to make an incorrect electrical connection impossible. The battery panel in the second configuration is removable, and slides in and out of place on the harness body. The harness body is equipped with a track, which is configured to interfit with a corresponding track on the battery panel, so that the battery panel fits into place on the harness body in a secure and controlled insertion path. The track on the harness body and the corresponding track on the battery panel can be configured in a number of different ways, one being a projection, another being a corresponding depression or cutout, or they can be rails such as a t-rail or a l-rail with the corresponding slot in the opposite piece.

One configuration of the removable battery panel can be one in which the harness body has one or more projections which interfit with one or more corresponding recesses or cutouts on the battery panel. These could take the form of slots, grooves, or cutouts, which correspond to the projections of the harness body.

The harness can also include a back piece, which is held adjacent but spaced apart from the harness body. This would be attached generally to the lower part of the harness body. The back piece would be for contact with the user's back and would separate the user's back from the rest of the harness body. In the spaced apart zone between the back piece and the harness body can be provided a slot or groove into which the battery panel may be slid. One or more projection slots on the spaced apart zone between the back piece and the harness body can provide the guidance and the structure for guiding the battery panel into place and into a controlled electrical connection with the harness body. For instance, a piece which has an orienting shape can be mounted between the back piece and the harness body. The orienting shape having straight sides or a pointed region the shape for corresponding engagement with the shape of a bottom edge of a battery panel, or with slots in the battery panel, or with grooves in the battery panel, or with projections in the battery panel.

The purpose of the Abstract of the invention is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 is a perspective view of the removable battery assembly of the invention.

FIG. 2 is a perspective view of the invention with a partially disassembled carrying harness.

FIG. 3 is a perspective view of the recharging station of the invention.

FIG. 4 is a perspective view of the recharging station with a battery plate attached.

FIG. 5 is a perspective view of a battery plate.

FIG. 6 is a perspective view of a backpack harness and a battery aligned but not connected.

FIG. 7 is a perspective view of the removable battery assembly of the invention mounted to a backpack vacuum.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

In the following description and in the figures, like elements are identified with like reference numerals. The use of “or” indicates a non-exclusive alternative without limitation unless otherwise noted. The use of “including” means “including, but not limited to,” unless otherwise noted.

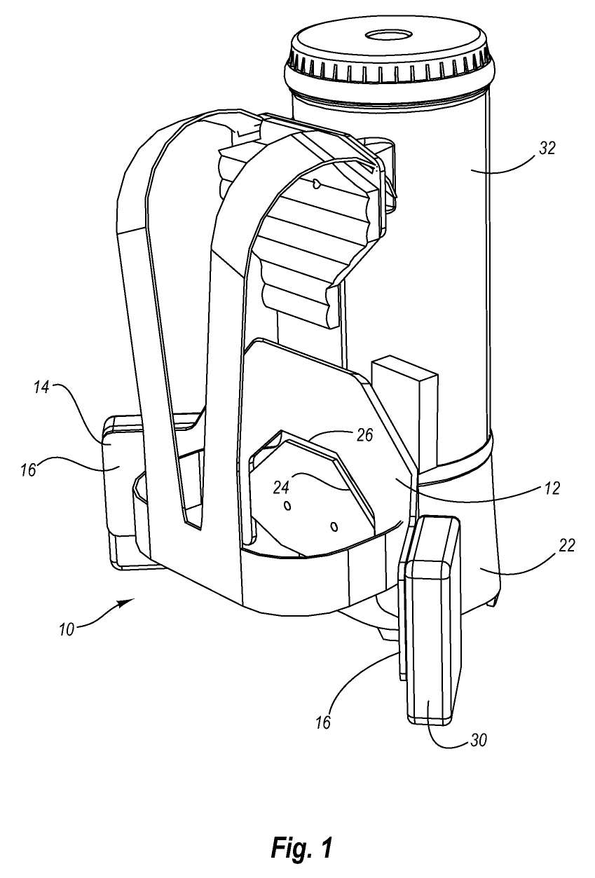

FIGS. 1 through 7 show the invention to advantage. FIG. 1 is a perspective view of the removable battery assembly 10 of the invention, mounted to a vacuum 32. The invention includes a battery plate 12, which includes mounting points 14 and battery mounting position 16. Also shown in FIG. 1 are batteries 30 attached to the battery plate 12 and the vacuum motor 22 of the vacuum 32.

Although the term “battery” is used throughout the application, by battery is meant any type of cordless power system, including batteries, capacitors, and super capacitors.

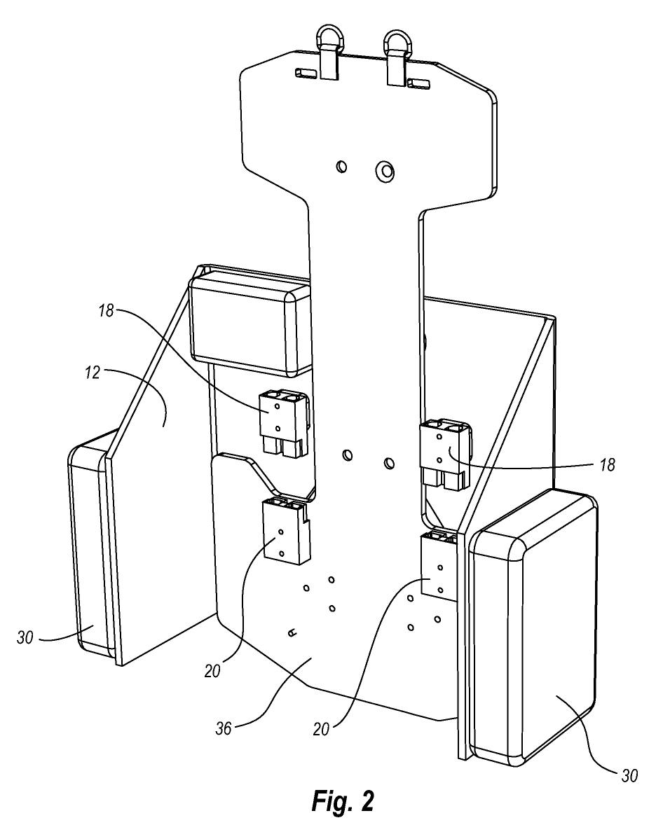

FIG. 2 shows the battery plate 12 with battery plate electrical connection units 18, which are approaching engagement with the vacuum electrical connection unit 20. The vacuum electrical connection unit 20 is attached to the backpack carrying harness 36.

The battery plate 12 includes an engagement profile 26 which is configured for engagement with an engagement guide 24 on the battery harness. The engagement profile 26 and the engagement guide 24 cause the battery plate to be guided into position on the backpack carrying harness 36, so that the electrical connections shown in FIG. 2 are correctly aligned, and move into electrical connection 20. These electrical connections 20 are also configured so that if the battery plate 12 is reversed, the electrical connection cannot be made. FIG. 2 shows the battery plate 12 of the invention mounted on a backpack carrying harness 36. Batteries 30 are mounted to the battery plate 12. The battery plate 12 also includes the battery plate electrical connection units 18, which are aligned for connection to the vacuum electrical connection units 20. By the use of the engagement guide 24 on the vacuum and the engagement profile 26 on the battery plate 12, these electrical connections 20 are guided into electrical engagement and prevented from being connected incorrectly.

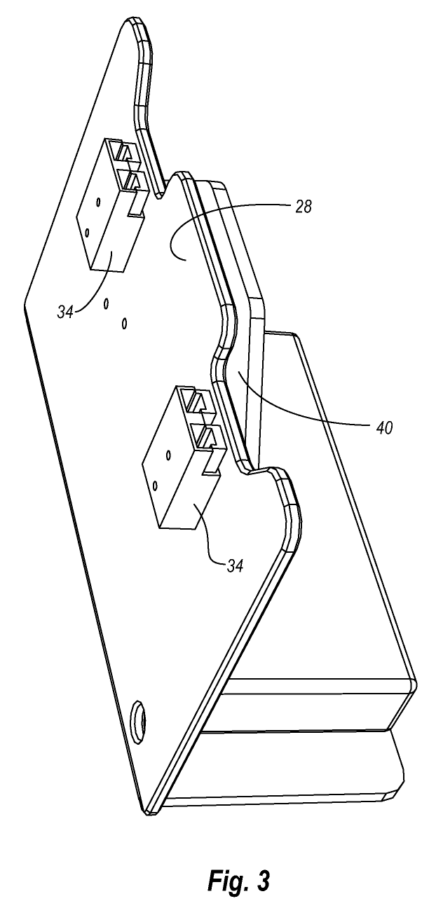

FIG. 3 shows the recharging station 28 of the invention. In the preferred embodiment, this unit is made to inter-fit with the battery plate 12 in a connection similar to the connection between the battery plate 12 and the backpack carrying harness 36. The recharging station includes charger electrical connection units 34 which are configured to engage with the battery plate electrical connection units 18. The recharging station includes a charger engagement guide 40, which is equivalent to the engagement guide 24 on the vacuum as shown in FIG. 1.

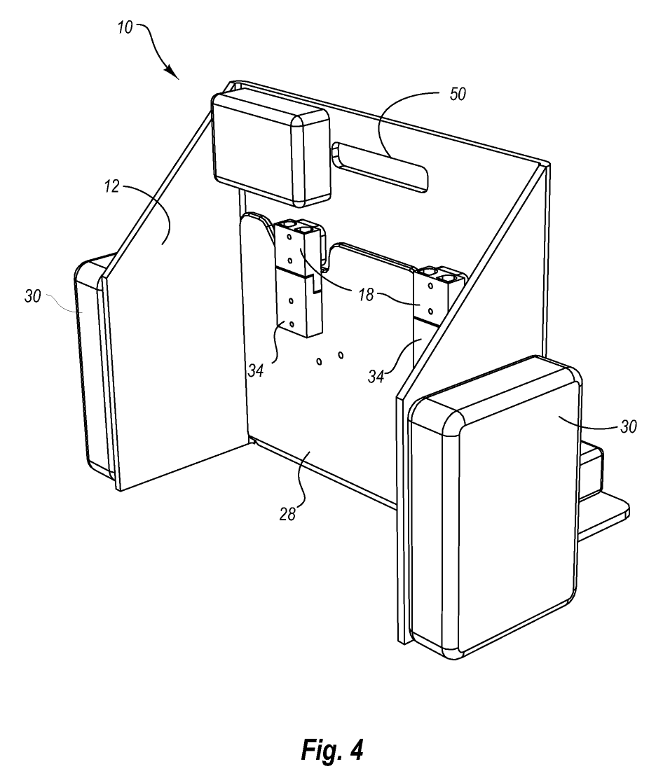

FIG. 4 shows the recharging station 28 of the invention. The view in FIG. 3 showed the electrical connection units 34. FIG. 4 shows the electrical connection units 18 fully engaged with the charger electrical connection units 34. FIG. 4 shows the battery plate 12, with a carrying handle 50, and with attached batteries 30. Attached to the battery plate 12 are battery plate electrical connection units 18, which are engaged with the charger electrical connection units 34 of the recharging station 28.

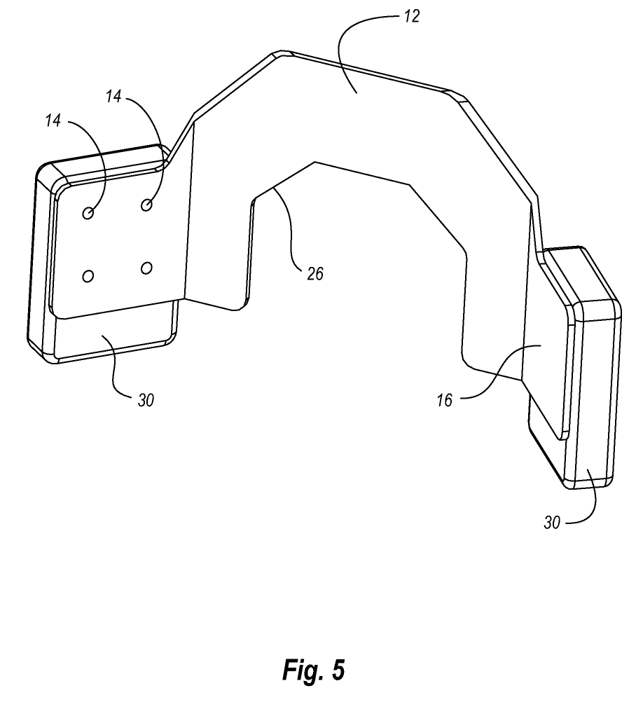

FIG. 5 is a perspective view of the battery plate 12 itself, with no vacuum or charging unit. The charging plate 12 includes mounting point 14, which form battery mounting positions 16. Batteries 30 are mounted on the battery mounting positions 16. The battery plate 12 includes an engagement profile 26 which is configured to fit with an engagement guide 40 on the recharging station 28 and the vacuum 32. Although other shapes can be utilized to ensure that the electrical connections are made accurately and correctly, the preferred version is shown in FIG. 5 which is an engagement profile on the battery plate 12 which forms a large, angular notch in the battery plate. The angular notch fits with the engagement guide 24 on the vacuum, which is an angular projection on the recharging station 28 on the vacuum to guide the connection between the battery plate 12 and either of these units.

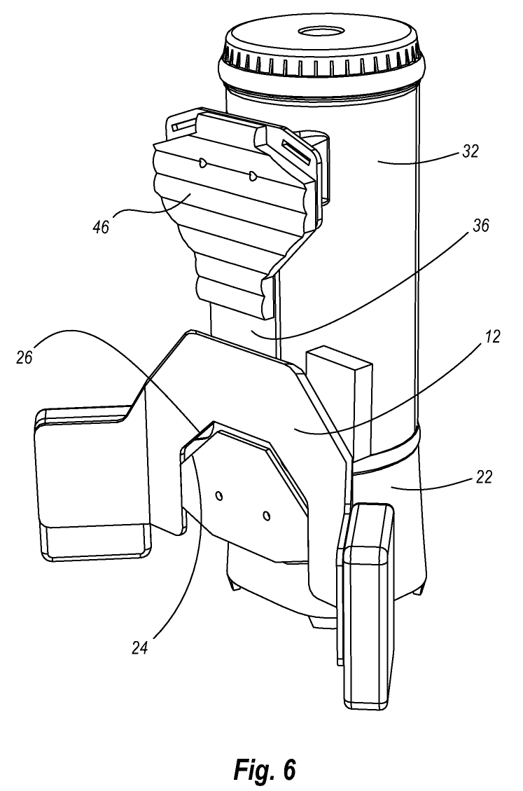

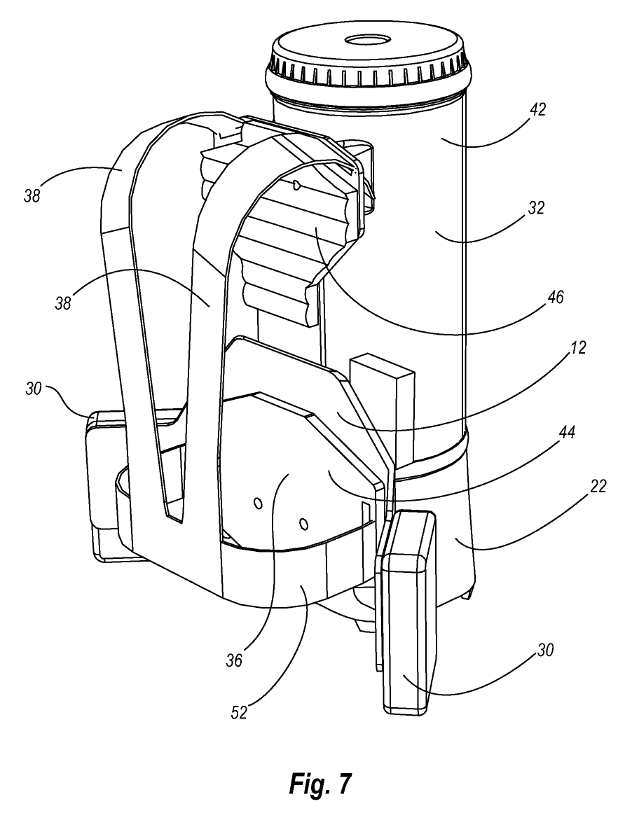

FIG. 6 is a perspective view of the battery plate 12 as it is approaching full engagement on the engagement guide 24 on the vacuum. In this case the engagement guide on the vacuum is part of the backpack carrying harness, but it could also be mounted on the body of the vacuum itself. Shown in FIG. 6 is the vacuum 32 with a motor 22 and an attached backpack carrying harness 36. Parts of the backpack carrying harness 36 include a back contact area 46 which is shown in FIG. 7. The battery plate 12 engages with the engagement guide 24 on the vacuum as shown in FIG. 6.

FIG. 7 is similar to FIG. 6, but a few more features of the carrying harness have been added. The lumbar contact plate 44 has been added, which obstructs the view of the interaction between the engagement guide 24 and the engagement profile 26 on the battery pack. The lumber contact plate 44 also forms a slot into which the battery plate 12 fits and helps to slide into accurate engagement with the engagement guide 24 on the vacuum. This version of the invention includes shoulder straps 38 and a belt 52 which aides in carrying the unit. This version of the vacuum 32 is a backpack vacuum, and although this is the preferred embodiment, the removable battery assembly of the invention can be equally adapted to other styles of backpack such as canisters and uprights.

While there is shown and described the present preferred embodiment of the invention, it is to be distinctly understood that this invention is not limited thereto, but may be variously embodied to practice within the scope of the following claims. From the foregoing description, it will be apparent that various changes may be made without departing from the spirit and scope of the invention as defined by the following claims.

I claim:

1. A removable battery assembly for a vacuum, comprising:
a battery plate for attachment of components, with the battery plate including one or more mounting points for attachment to said vacuum, with the battery plate including one or more battery mounting positions for attaching one or more batteries to the battery plate, and an electrical connection unit for interfitting engagement with a corresponding vacuum electrical connection unit, for electrical engagement of the batteries on the battery plate with a vacuum motor;
an engagement guide on said vacuum for interaction with a corresponding engagement profile on said battery plate, for ensuring correct engagement of the battery plate mounting points to said vacuum, and for correct engagement of the battery plate electrical connection unit with the vacuum electrical connection unit; and
a recharging station with an electrical connection unit for corresponding engagement with the battery plate electrical connection unit; wherein
said battery plate may be engaged with said vacuum for a period of time, and then may be removed from the vacuum, replaced by another battery plate, and engaged with the recharging for a period of time, with the battery plate engaging with the vacuum by use of said engagement guide and said engagement profile in a manner which ensures correct engagement of electrical components.

2. The removable battery assembly for a vacuum of claim 1, in which said recharging station further comprises an engagement guide corresponding to the engagement profile of said battery plate, for correct engagement of the battery plate electrical connection unit with the recharging station electrical connection unit.

3. The removable battery assembly for a vacuum of claim 2, in which said battery plate is configured to interfit with a backpack vacuum.

4. The removable battery assembly for a vacuum of claim 3, in which said battery plate is configured to interfit with an engagement guide and mounting position an said backpack vacuum, in a position between a backpack carrying harness and the backpack vacuum body.

5. The removable battery assembly for a vacuum of claim one, which includes a carrying harness with shoulder straps which is configured to attach to a backpack vacuum, with the battery plate removable from the carrying harness attached to the backpack vacuum.

6. A removable battery assembly for a vacuum, comprising:
a battery plate for attachment of components, with the battery plate including one or more mounting points for attachment to said vacuum and configured to interfit with a backpack vacuum containing an engagement guide and battery plate mounting position, with the battery plate including one or more battery mounting positions for attaching one or more batteries to the battery plate, and an electrical connection unit for interfitting engagement with a corresponding vacuum electrical connection unit, for electrical engagement of the batteries on the battery plate with a vacuum motor;
an engagement guide on said vacuum for interaction with a corresponding engagement profile on said battery plate, for ensuring correct engagement of the battery plate mounting points to said vacuum, and for correct engagement of the battery plate electrical connection unit with the vacuum electrical connection unit; and
a recharging station with an electrical connection unit for corresponding engagement with the battery plate electrical connection unit, with said recharging station comprising an engagement guide corresponding to the engagement profile of said battery plate, for correct engagement of the battery plate electrical connection unit with the recharging station electrical connection unit; wherein
said battery plate may be engaged with said vacuum for a period of time, and then may be removed from the vacuum, replaced by another battery plate, and engaged with the recharging for a period of time, with the battery plate engaging with the vacuum by use of said engagement guide and said engagement profile in a manner which ensures correct engagement of electrical components.

7. The removable battery assembly for a vacuum of claim 6, which includes a carrying harness with shoulder straps which is configured to attach to a backpack vacuum, with the battery plate attachable and removable from the carrying harness attached to the backpack vacuum.

8. A removable battery assembly for a backpack vacuum, comprising:
a harness body to which harness components are attached, and which includes one or more mounting points for attachment to said backpack vacuum, and a first end and second end, with the harness body including one or more battery mounts for removable engagement with one or more batteries, and an electrical connection means for interfitting engagement with the battery electrical contacts;
two shoulder straps for providing lifting capability for a user of said backpack vacuum, each with an upper end and a lower end, with said upper ends for attachment to said first end of said harness body, and with said lower ends for attachment to said second end said harness body;
a back contact area attached to said upper section of said harness body;
a lumbar contact area attached to said lower section of said harness body;
one or more batteries for engagement with said battery mounts on said harness body, with each battery including electrical contacts for engagement with said electrical connection means of said battery mounts of said harness body; wherein
said harness body electrical connection means is configured to interfit with said battery electrical contacts, with the battery mounts providing attachment points for the one or more batteries.

9. A removable battery assembly for a backpack vacuum, comprising:
a harness body to which harness components are attached, and which includes one or more mounting points for attachment to said backpack vacuum, and a first end and second end, with the harness body including a harness body electrical connection unit and a battery plate mounting position with an engagement guide for interaction with a corresponding engagement profile on a battery plate, for ensuring correct engagement of the battery plate to said harness body, and for correct engagement of a battery plate electrical connection unit with a harness body electrical connection unit, with the harness body electrical connection unit configured for electroical connection to the vacuum motor;
the battery plate for attachment of components, with the battery plate including one or more battery mounting positions for attaching one or more batteries to the battery plate, and an electrical connection unit for interfitting engagement with a corresponding harness electrical connection unit, for electrical engagement of the batteries on the battery plate with the harness body electrical connection unit;
two shoulder straps for providing lifting capability for a user of said backpack vacuum, each with an upper end and a lower end, with said upper ends for attachment to said first end of said harness body, and with said lower ends for attachment to said second end said harness body;
a back contact area attached to said upper section of said harness body;
a lumbar contact area attached to said lower section of said harness body; wherein
said harness body electrical connection unit is configured to interfit with said battery plate electrical connection unit in a guided manner which prevents incorrect connection, for powering the vacuum motor, and with the battery plate removable for recharging of the batteries.

10. A removable battery assembly for a backpack vacuum, comprising:
a harness body to which harness components are attached, and which includes one or more mounting points for attachment to said backpack vacuum, and a first end and second end, with the harness body including a battery plate mounting position with an engagement guide for interaction with a corresponding engagement profile on a battery plate, for ensuring correct engagement of the battery plate to said harness body, and for correct engagement of a battery plate electrical connection unit with a vacuum body electrical connection unit, with the vacuum body electrical connection unit configured for electrical connection to the vacuum motor;
the battery plate for attachment of components, with the battery plate including one or more battery mounting positions for attaching one or more batteries to the battery plate, and an electrical connection unit for interfitting engagement with a corresponding vacuum body electrical connection unit, for electrical engagement of the batteries on the battery plate with the vacuum body electrical connection unit;
two shoulder straps for providing lifting capability for a user of said backpack vacuum, each with an upper end and a lower end, with said upper ends for attachment to said first end of said harness body, and with said lower ends for attachment to said second end said harness body;
a back contact area attached to said upper section of said harness body;
a lumbar contact area attached to said lower section of said harness body; wherein
said vacuum body electrical connection unit is configured to interfit with said battery plate electrical connection unit in a guided manner which prevents incorrect connection, for powering the vacuum motor and with the one or more batteries.

11. A harness for a backpack vacuum, comprising:
a harness body to which harness components are attached, and which includes one or more mounting points for attachment to said backpack vacuum, and an upper and a lower section, with the harness body including one or more tracks for interfitting engagement with a battery plate, and an electrical connection post for interfitting engagement with a battery plate engagement socket;
two shoulder straps for providing lifting capability for a user of said backpack vacuum, each with an upper end and a lower end, with said upper ends for attachment to said upper section of said harness body, and with said lower ends for attachment to said lower section of said harness body;
a back contact area attached to said upper section of said harness body;
a lumbar contact area attached to said lower section of said harness body;
one or more removable battery plates for engagement with said harness body, with each battery plate including one or more batteries for operation of said backpack vacuum, and a battery housing for holding each battery, with each battery housing including interfitting electrical contacts for engagement with electrical contacts of said battery, and with each of said battery plates including an electrical engagement socket for interfitting engagement with the electrical connection post of said harness body, and with each battery plate including a plate track for interfitting engagement with said track of said harness body; wherein
said harness body track is configured to interfit with said plate track of said battery plate, so that the tracks guide the electrical connection post and the electrical connection socket into interfitting engagement, so that when the tracks are engaged they direct the electrical connection of the electrical connections and prevent in incorrect electrical connection.

12. The harness for a backpack vacuum of claim 9 in which the engagement guide of the harness body is one or more slots which interfit with one or more corresponding projections on the battery plate, with the projections forming the engagement profile of the battery plate.

13. The harness for a backpack vacuum of claim 9 in which the engagement guide of the harness body is one or more slots which interfit with one or more corresponding projections on the battery plate, with the projections forming said engagement profile.

14. The harness for a backpack vacuum of claim 9 in which said harness engagement guide comprises a tapered profile and said battery plate engagement profile comprises a tapered key configured for mating with said tapered profile.

15. The harness for a backpack vacuum of claim 14 in which the harness body includes a back piece that is held in spaced apart relationship to the harness body, thus forming a gap into which the battery plate fits.

16. The harness for a backpack vacuum of claim 12 in which said battery plate track is a slot that fits around a projecting section that forms the track of the harness body.

17. The harness for a backpack vacuum of claim 15 in which the back piece and the harness body are held apart by the track of the harness, which has a shape that corresponds to one or more slots of the battery plate, with the track forming a gap between the back piece and the harness body into which the battery plate slips.

18. A harness for a backpack vacuum, comprising:
a harness body to which harness components are attached, and which includes one or more mounting points for attachment to said backpack vacuum, and an upper and a lower section, with the harness body including one or more battery mounts for removable engagement with a battery or a battery panel, and an electrical connection means for interfitting engagement with the battery electrical contacts;
two shoulder straps for providing lifting capability for a user of said backpack vacuum, each with an upper end and a lower end, with said upper ends for attachment to said upper section of said harness body, and with said lower ends for attachment to said lower section of said harness body;
a back contact area attached to said upper section of said harness body;
a lumbar contact area attached to said lower section of said harness body;
one or more batteries for engagement with said battery mounts on said harness body, with each battery including electrical contacts for engagement with said electrical connection means of said battery mounts of said harness body; wherein
said harness body electrical connection means is configured to interfit with said battery electrical contacts, with the battery mounts guiding the interfitting of the battery contacts with the electrical connection means of the harness body and configured to make an incorrect battery orientation impossible.

19. A harness for a backpack vacuum, comprising:
a harness body to which harness components are attached, and which includes one or more mounting points for attachment to said backpack vacuum, and an upper and a lower section, with the harness body including one or more tracks for interfitting engagement with a battery panel, and an electrical connection post for interfitting engagement with a battery panel engagement socket;
two shoulder straps for providing lifting capability for a user of said backpack vacuum, each with an upper end and a lower end, with said upper ends for attachment to said upper section of said harness body, and with said lower ends for attachment to said lower section of said harness body;
a back contact area attached to said upper section of said harness body;
a lumber contact area attached to said lower section of said harness body;
one or more removable battery panels for engagement with said harness body, with each battery panel including one or more batteries for operation of said backpack vacuum, and a battery housing for holding each battery, with each battery housing including interfitting electrical contacts for engagement with electrical contacts of said battery, and with each of said battery panels including an electrical engagement socket for interfitting engagement with the electrical connection post of said harness body, and with each battery panel including a panel track for interfitting engagement with said track of said harness body; wherein
said harness body track is configured to interfit with said panel track of said battery panel, so that the tracks guide the electrical connection post and the electrical connection socket into interfitting engagement, so that when the tracks are engaged they direct the electrical connection of the electrical connections and prevent in incorrect electrical connection.

20. The harness for a backpack vacuum of claim 2 in which the track of the harness body is one or more projection which interfit with one or more corresponding recesses on the battery panel.

21. The harness for a backpack vacuum of claim 2 in which the track of the harness body is one or more slots which interfit with one or more corresponding projections on the battery panel.

22. The harness for a backpack vacuum of claim 2 in which said battery housing is configured to make incorrect battery connection impossible.

23. The harness for a backpack vacuum of claim 3 in which said battery panel track is a slot that fits around a projecting section that forms the track of the harness body.

24. The harness for a backpack vacuum of claim 6 in which the harness body includes a back piece that is held in spaced apart relationship to the harness body, thus forming a gap into which the battery panel fits.

25. The harness for a backpack vacuum of claim 7 in which the back piece and the harness body are held apart by the track of the harness, which has a shape that corresponds to one or more slots of the battery panel, with the track forming a gap between the back piece and the harness body into which the battery panel slips.
